(19) United States
(12) Patent Application Publication
(10) Pub. No.: US 2017/0014306 A1
(43) Pub. Date: Jan. 19, 2017

(54) PACKAGING ENCLOSING LOZENGE PRODUCTS AND BLANK FOR OBTAINING SAID PACKAGING

(71) Applicant: SANOFI, Paris (FR)

(72) Inventor: Guilhem Rousselet, Saint-Maur (FR)

(73) Assignee: Sanofi, Paris (FR)

(21) Appl. No.: 14/902,534

(22) PCT Filed: Jul. 1, 2014
(86) PCT No.: PCT/FR2014/051691

§ 371 Date: Dec. 31, 2015

(30) Foreign Application Priority Data
Jul. 4, 2013 (FR) 1356580

(51) Int. Cl. A61J 1/03; B65D 5/42; B65D 75/58; B65D 75/36

(52) U.S. Cl. CPC A61J 1/035; B65D 75/367; B65D 5/4266; B65D 75/58

(57) ABSTRACT

The packaging comprises a cover (10) and a diptych (11), to be arranged in the same way as a book. The packaging comprises a case (2) comprising a cover part (26) and a diptych part (27), said cover part (26) forming said cover (10), a first blister plate (3) and a second blister plate (4) and the diptych part (27) forming said diptych (11); an intermediate panel (30) of said cover part (26) forming a back (14) of said cover (10) and an intermediate panel (51) of said diptych part (27) forming a back (17) of said diptych (11), with a side (43) of said intermediate panel (30) of said cover part (26) that is linked by a bridge (18) to a side (65) of said intermediate panel (51) of said diptych part (27). The blank is arranged to form the case (2).

The invention deals with the packagings that enclose lozenge products such as unitary pharmaceutical products in the form of tablets, capsules or hard gelatin capsules.

It is known that the unitary pharmaceutical products are generally packaged in a blister plate formed by a base comprising a plurality of protuberances and by a film, with each protuberance having a cavity in which a unitary pharmaceutical product is arranged and each protuberance being closed by the film such that each unitary pharmaceutical product is retained in the cavity in which it is arranged.

To extract a unitary pharmaceutical product from a blister plate, pressure is applied to a protuberance to deform it and act on the unitary pharmaceutical product which is then driven toward the film, the latter tears and the unitary pharmaceutical product can be recovered.

In general, the unitary pharmaceutical products are distributed and marketed in boxes in which a number of blister plates containing the unitary pharmaceutical products are placed.

The boxes containing the blister plates are often bulky and not very convenient to handle. Some users therefore directly carry a blister plate with them, for example in a handbag or in a pocket but, since the film of the blister plate is not protected, it tears inadvertently and one or more of the unitary pharmaceutical products escape from the blister plate.

Various packagings have already been proposed that are easy to handle and transport, for example in an handbag or in a pocket, in which the blister plates are protected.

Thus, there is already known, notably through the German utility model 6930899, through the German patent application DE 44 29 503 and through the French patent application 2 764 274, a packaging enclosing unitary pharmaceutical products organized in the manner of a book.

Such a packaging comprises a cover and a diptych arranged in the cover.

The diptych comprises a first flap formed by a first blister plate, a second flap formed by a second blister plate and a back arranged between the first flap and the second flap.

The cover comprises a first flap, a second flap and a back arranged between the first flap and the second flap, the back of the diptych being attached to the back of the cover.

To transport the packaging, it is placed in a closed configuration in which the two flaps of the diptych are against one another, the first flap of the cover is against the first flap of the diptych and the second flap of the cover is against the second flap of the diptych.

To extract a unitary pharmaceutical product from the packaging, the packaging is placed in an open configuration in which the diptych flap containing the blister plate enclosing the unitary pharmaceutical product that is to be extracted is separated from the other flap of the diptych and separated from the cover such that pressure can be applied to the protuberance to extract the unitary pharmaceutical product.

The invention aims to make it possible to obtain such a packaging in a simple, convenient and economical manner.

To this end, it proposes a packaging enclosing lozenge products, comprising a cover and a diptych arranged in said cover, said diptych comprising a first flap comprising a first blister plate, a second flap comprising a second blister plate and a back arranged between said first flap and said second flap; each said first blister plate and second blister plate comprising a film and a base having protuberances, each said lozenge product being arranged in a cavity of one said protuberance closed by said film; said cover comprising a first flap, a second flap and a back arranged between said first flap and said second flap; said back of said diptych being fixed to said back of said cover, by virtue of which said packaging is organized in the manner of a book;

said packaging being characterized in that it comprises a case comprising a cover part and a diptych part, said cover part forming said cover, said first blister plate and second blister plate and the diptych part forming said diptych; an intermediate panel of said cover part forming said back of said cover and an intermediate panel of said diptych part forming said back of said diptych, with a side of said intermediate panel of said cover part which is linked by a bridge to a side of said intermediate panel of said diptych part.

In the packaging according to the invention, contrary to the abovementioned prior packagings, the flaps of the diptych are not directly formed by blister plates joined to one another by the back of the diptych, but by conventional individual blister plates and by the diptych part of the case.

The packaging according to the invention thus offers the advantage of not requiring the implementation of specific blister plates, joined to one another by a back, but conventional blister plates associated with a part of the diptych of a case which can be made from a blank of flexible and pliable material such as cardboard.

By virtue of the bridge linking the intermediate panel of the diptych part forming the diptych back and the intermediate panel of the cover part forming the back of the cover, the cover part and the diptych part of the packaging according to the invention are not separate components.

On the contrary, the cover part and the diptych part are joined by a bridge to be one and the same component.

Consequently, apart from the first blister plate and the second blister plate, a single component is sufficient to obtain the packaging according to the invention.

According to advantageous features of the packaging according to the invention:
said diptych part comprises two panels sandwiching said first blister plate and two panels sandwiching said second blister plate;
said diptych part comprises a single panel to which said first blister plate is fixed and a single panel to which said second blister plate is fixed; and/or
the packaging comprises a closure device for keeping said packaging in a closed configuration.

Another aim of the invention, under another aspect, is a blank for obtaining a packaging as explained above, characterized in that it comprises, to form a case for this packaging:
a cover part to form a cover of said packaging, said cover part comprising a first panel to form a first flap of said cover, a second panel to form a second flap of said cover, and an intermediate panel arranged between said first panel and said second panel to form a back of said cover;
   a diptych part to form a diptych of said packaging, said diptych part comprising a first panel to receive a first blister plate and to form with said first blister plate a first flap of said diptych, a second panel to receive a second blister plate and to form with said second blister plate a second flap of said diptych, and an intermediate panel arranged between said first panel and said second panel of said diptych part to form a back of said diptych; and
   a bridge linking a side of said intermediate panel of said cover part to a side of said intermediate panel of said diptych part; a first groove and a second groove being arranged on either side of said bridge and formed respectively between said first panel of said cover part and said first panel of said diptych part, and between said second panel of said cover part and said second panel of said diptych part.

According to advantageous features, each said groove has a same width as said bridge.

In a first advantageous embodiment, said diptych part further comprises a third panel and a fourth panel, said diptych part being configured to sandwich said first blister plate between said first panel and said third panel, and to sandwich said second blister plate between said second panel and said fourth panel.

In a first mode of execution of this first embodiment, said diptych part comprises a main part and a complementary part organized in a manner similar to the main part, with said first panel and said second panel belonging to said main part, and with said third panel and said fourth panel belonging to said complementary part.

In a second mode of execution of this first embodiment, said third panel has a side adjacent to a side of said first panel whereas its other sides are free; and said fourth panel has a side adjacent to a side of said second panel whereas its other sides are free.

In a second embodiment, advantageous for its simplicity, said diptych part comprises no panel other than said first panel, said second panel and said intermediate panel.

The explanation of the invention will now be continued by the detailed description of exemplary embodiments, given hereinbelow in an illustrative and nonlimiting manner, with reference to the attached drawings. In these:

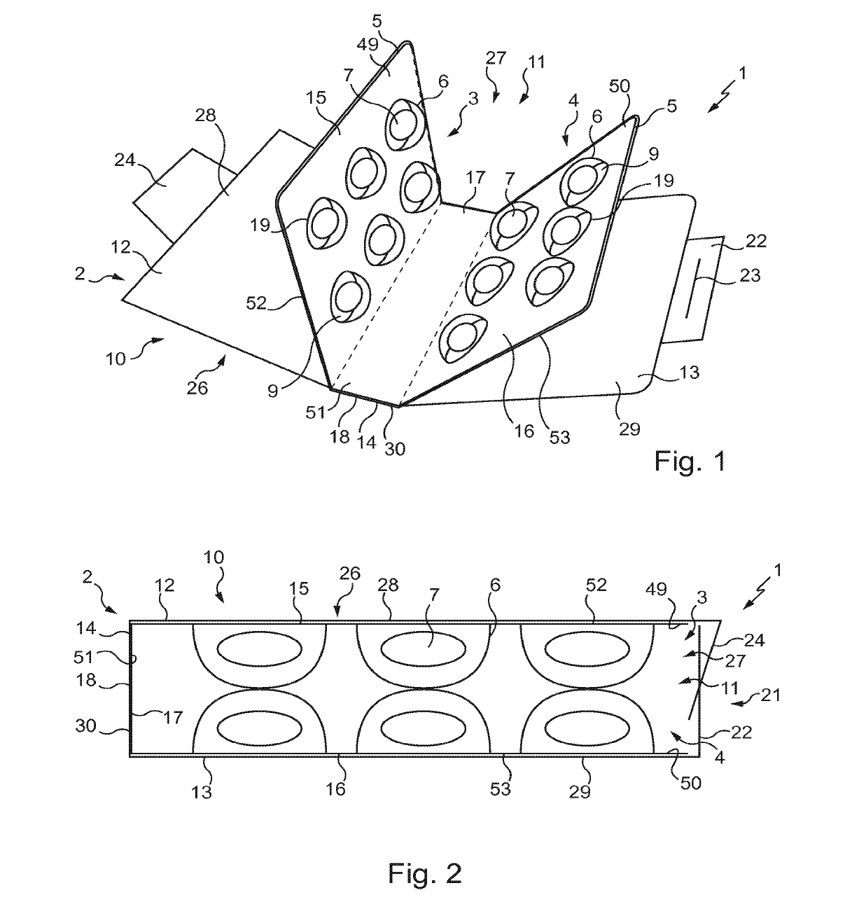

FIG. 1 is a perspective view, very schematic, of a packaging according to the invention in an open configuration;

FIG. 2 is a very schematic view in elevation of this packaging, in closed configuration;

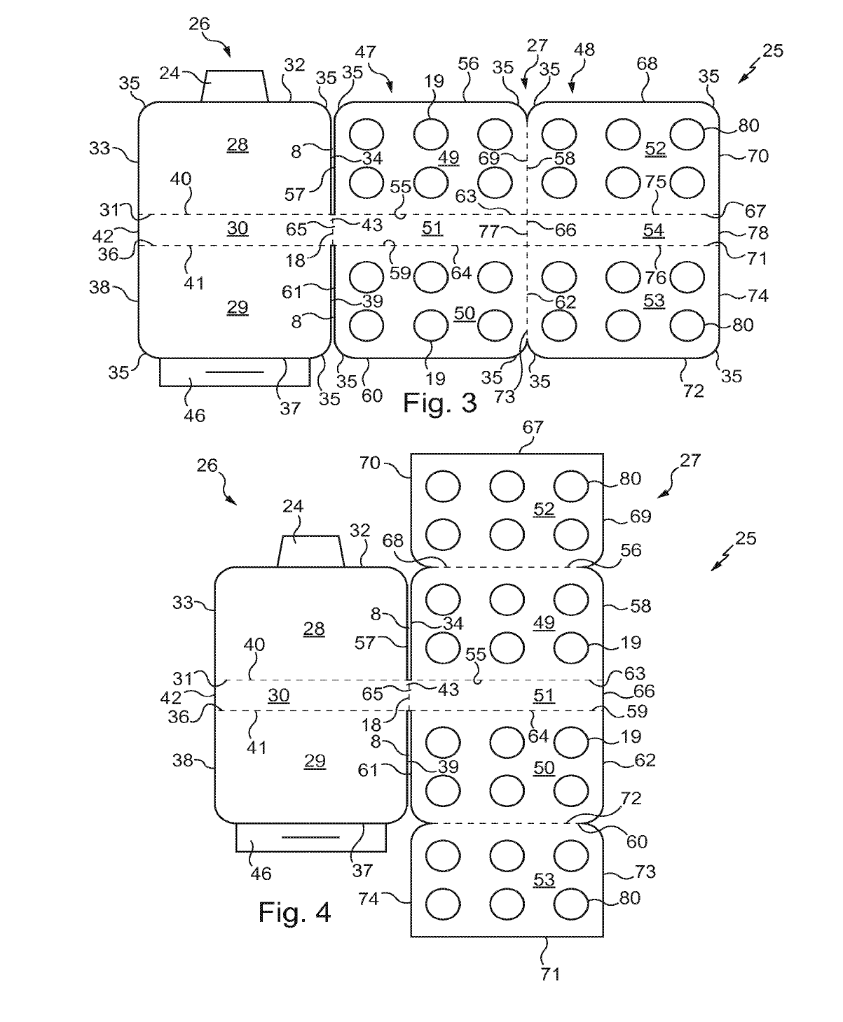

FIG. 3 is a plan view of a blank to obtain the packaging illustrated in FIGS. 1 and 2;

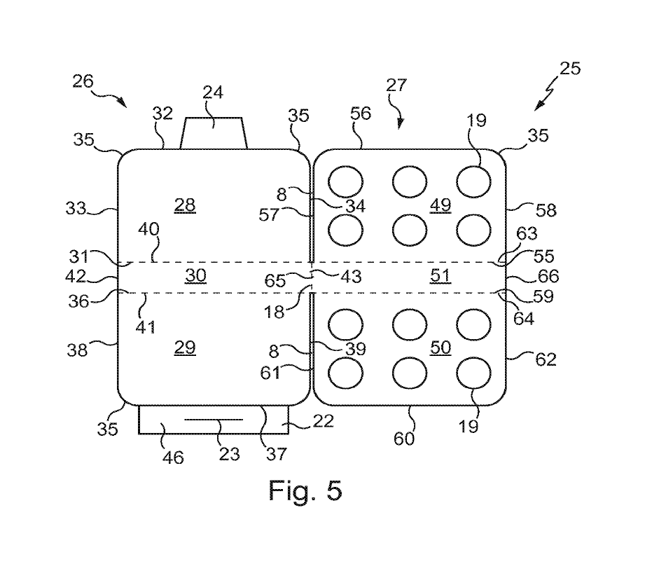

FIGS. 4 and 5 are views similar to FIG. 3, for variants of the blank.

In the drawings, the fold lines are presented by broken lines.

FIG. 1 illustrates a packaging 1 according to the invention in an open configuration.

The packaging 1 comprises a cover 10 and a diptych 11 arranged in the cover 10.

The cover 10 comprises a first flap 12, a second flap 13 and a back 14 arranged between the first flap 12 and the second flap 13.

The diptych 11 comprises a first flap 15 comprising a blister plate 3, a second flap 16 comprising a blister plate 4, and a back 17 arranged between the first flap 15 and the second flap 16.

The blister plates 3 and 4 each comprise a film 9 and a base 5 comprising a plurality of protuberances 6. Each protuberance 6 has a cavity in which a unitary pharmaceutical product 7 is arranged; each protuberance 6 is closed by the film 9 thus retaining each unitary pharmaceutical product 7 in its protuberance 6.

The unitary pharmaceutical products 7 are, for example, tablets, capsules or hard gel capsules.

The first flap 15 of the diptych 11 has a plurality of openings 19 from each of which emerges one of the protuberances 6 of the plate 3.

The second flap 16 of the diptych 11 has a plurality of openings 19 from each of which emerges one of the protuberances 6 of the plate 4.

The flaps 15 and 16 will be described in more detail hereinbelow in this document.

The back 17 of the diptych 11 has dimensions similar to those of the back 14 of the cover 10.

The back 17 and the back 14 are superposed with the back 17 which covers the back 14 on the internal side of the cover 10.

The back 17 and the back 14 are attached to one another, here by bonding.

A bridge 18 links one of the small sides of the back 17 of the diptych 11 to the corresponding small side of the back 14 of the cover 10.

As explained hereinbelow, the bridge 18 is useful for manufacturing the packaging 1.

The first flap 15 and the second flap 16 of the diptych 11 have similar dimensions and are each articulated with respect to the back 17 around a respective one of the large sides thereof. Similarly, the first flap 12 and the second flap 13 of the cover 10 have similar dimensions and are each articulated with respect to the back 14 about one of the respective large sides thereof.

Thus, generally, the packaging 1 is organized in the manner of a book.

In the open configuration illustrated in FIG. 1, the diptych 11 is in an unfolded position in which the first flap 15 and the second flap 16 are separated from one another. Thus, the protuberances 6 of the plate 3 are separated from the protuberances 6 of the plate 4. The user can thus access each of the protuberances 6 of each plate 3 and 4.

FIG. 2 illustrates the packaging 1 in a closed configuration.

In this closed configuration, the diptych 11 is in a closed position in which the first flap 15 is brought as close as possible to the second flap 16. Thus, the protuberances 6 of the plate 3 are each in contact with a protuberance 6 of the plate 4.

In this closed configuration, the first flap 12 of the cover 10 is in contact with the first flap 15 of the diptych 11 whereas the second flap 13 of the cover 10 is in contact with the second flap 16 of the diptych 11.

The packaging 1 is kept in its closed configuration by a closure device 21.

The closure device 21 here comprises a lateral flap 22 having a slit 23 and a tongue 24 configured to be inserted into the slit 23 of the lateral flap 22.

In the closed configuration, the tongue 24 is inserted into the slit 23.

The closed configuration allows the packaging 1 to be transported, for example in a handbag or in a pocket.

In the closed configuration, the film 9 of each of the blister plates 3 and 4 is protected since it is covered by the first flap 12 or the second flap 13 of the cover 10.

To extract a unitary pharmaceutical product 7 from the packaging 1, the closure device 21 is unlocked, by extracting the tongue 24 from the slit 23, the packaging 1 is switched to an open configuration, pressure is applied to one of the protuberances 6 to drive the unitary pharmaceutical product 7 toward the film 9, the latter tears in line with the unitary pharmaceutical product 7, which can then leave the cavity and be recovered.

The packaging 1 is formed by the association of the blister plate 3 and of the blister plate 4 with a case 2 made of a material in the form of a supple and flexible sheet such as cardboard.

The case 2 comprises a cover part 26 and a diptych part 27.

The cover 10 of the packaging 1 is formed by the cover part 26 of the case 2. The diptych 11 of the packaging 1 is formed by the diptych part 27 of the case 2, by the blister plate 3 and by the blister plate 4.

There now follows a description, by reference to FIG. 3, of a blank 25 that makes it possible to form the case 2 and obtain the packaging 1.

Generally, once folded and bonded, the blank 25 becomes the case 2 of the packaging 1.

The same terminology and the same numerical references are therefore employed for the case 2 and for the blank 25.

The cover part 26 comprises a first cover panel 28, a second cover panel 29 and an intermediate cover panel 30 arranged between the first panel 28 and the second panel 29.

In the case 2, the first cover panel 28 forms the first cover flap 12, the second cover panel 29 forms the second cover flap 13 and the intermediate cover panel 30 forms the cover back 14.

The first cover panel 28 has a rectangular perimeter formed by four sides, respectively a first side 31 and a second side 32 which are opposite and a third side 33 and a fourth side 34 which are opposite. The second side 32 is linked to the third and fourth sides 33 and 34 by two rounded edges 35.

The second cover panel 29 has a rectangular perimeter formed by four sides, respectively a first side 36 and a second side 37 which are opposite and a third side 38 and a fourth side 39 which are opposite. The second side 37 is linked to the third and fourth sides 38 and 39 by two rounded edges 35.

The intermediate cover panel 30 has a rectangular perimeter formed by four sides, respectively a first side 40 and a second side 41 which are opposite and a third side 42 and a fourth side 43 which are opposite.

Here, the first side 31 of the first cover panel 28 and the first side 40 of the intermediate cover panel 30 are adjacent and formed by a fold line.

Similarly, the first side 36 of the second cover panel 29 and the second side 41 of the intermediate cover panel 30 are adjacent and formed by a fold line.

The cover part 26 further comprises the tongue 24 extending from the second side 32 of the first cover panel 28, and a lateral panel 46 to form the lateral flap 22 extending from the second side 37 of the second cover panel 29.

The diptych part 27 comprises a main diptych part 47 and a complementary diptych part 48.

The main diptych part 47 comprises a first diptych panel 49, a second diptych panel 50 and a first intermediate diptych panel 51 arranged between the first and second diptych panels 49 and 50.

The complementary diptych part 48 comprises a third diptych panel 52, a fourth diptych panel 53 and a second intermediate diptych panel 54 arranged between the third and fourth diptych panels 52 and 53.

The first diptych panel 49 has a rectangular perimeter formed by four sides, respectively a first side 55 and a second side 56 which are opposite and a third side 57 and a fourth side 58 which are opposite. The second side 56 is linked to the third and fourth sides 57 and 58 by two rounded edges 35.

The first diptych panel 49 comprises the plurality of openings 19 each configured to receive one of the protuberances 6 of the blister plate 3.

The second diptych panel 50 has a rectangular perimeter formed by four sides, respectively a first side 59 and a second side 60 which are opposite and a third side 61 and a fourth side 62 which are opposite. The second side 60 is linked to the third and fourth sides 61 and 62 by two rounded edges 35.

The second diptych panel 50 comprises the plurality of openings 19 each configured to receive one of the protuberances 6 of the blister plate 4.

The first intermediate diptych panel 51 has a rectangular perimeter formed by four sides, respectively a first side 63 and a second side 64 which are opposite and a third side 65 and a fourth side 66 which are opposite.

Here, the first side 55 of the first diptych panel 49 and the first side 63 of the first intermediate diptych panel 51 are adjacent and formed by a fold line.

Similarly, the first side 59 of the second diptych panel 50 and the second side 64 of the first intermediate diptych panel 51 are adjacent and formed by a fold line.

The bridge 18 extends between the fourth side 43 of the intermediate cover panel 30 and the third side 65 of the intermediate diptych panel 51.

Midway between the sides 43 and 65, the bridge 18 has a fold line.

The bridge 18 is the only portion of material linking the cover part 26 and the diptych part 27. Two grooves 8, of the same width as the bridge 18, are present on either side of the bridge 18.

The first cover panel 28 is thus separated from the first diptych panel 49 by a groove 8 delimited longitudinally respectively by the fourth side 34 of the first cover panel 28 and by the third side 57 of the first diptych panel 49.

Similarly, the second cover panel 29 is separated from the second diptych panel 50 by the other groove 8, which is delimited longitudinally by the fourth side 39 of the second cover panel 29 and by the third side 61 of the second diptych panel 50.

The third diptych panel 52 has a rectangular perimeter formed by four sides, respectively a first side 67 and a second side 68 which are opposite and a third side 69 and a fourth side 70 which are opposite. The second side 68 is linked to the third and fourth sides 69 and 70 by two rounded edges 35.

The third diptych panel 52 comprises a plurality of openings 80 each configured to be aligned with a portion of the film 9 closing one of the protuberances 6 of the blister plate 3.

The fourth diptych panel 53 has a rectangular perimeter formed by four sides, respectively a first side 71 and a second side 72 which are opposite and a third side 73 and a fourth side 74 which are opposite. The second side 72 is linked to the third and fourth sides 73 and 74 by two rounded edges 35.

The fourth diptych panel 53 comprises a plurality of openings 80 each configured to be aligned with a portion of the film 9 closing one of the protuberances 6 of the blister plate 4.

The second intermediate diptych panel 54 has a rectangular perimeter formed by four sides, respectively a first side 75 and a second side 76 which are opposite and a third side 77 and a fourth side 78 which are opposite.

Here, the first side 67 of the third diptych panel 52 and the first side 75 of the second intermediate diptych panel 54 are adjacent and formed by a fold line.

Similarly, the first side 71 of the fourth diptych panel 53 and the second side 76 of the second intermediate diptych panel 54 are adjacent and formed by a fold line.

Here, the fourth side 58 of the first diptych panel 49 and the third side 69 of the third diptych panel 52 are adjacent and formed by a fold line; the fourth side 66 of the first intermediate diptych panel 51 and the third side 77 of the second intermediate diptych panel 54 are adjacent and formed by a fold line; and the fourth side 62 of the second diptych panel 50 and the third side 73 of the fourth diptych panel 53 are adjacent and formed by a fold line.

The sides 58, 69, 66, 77, 62 and 73 are aligned and formed by a same fold line situated between the main diptych part 47 and the complementary diptych part 48.

Generally, the complementary diptych part 48 is similar to the main diptych part 47.

Thus, the third diptych panel 52, the second intermediate diptych panel 54 and the fourth diptych panel 53 have dimensions similar to those respectively of the first diptych panel 49, of the first intermediate diptych panel 51 and of the second diptych panel 50.

There now follows a description of how to obtain the packaging 1 from the blank 25 and the blister plates 3 and 4.

The blister plates 3 and 4 are arranged respectively on the first diptych panel 49 and on the second diptych panel 50 such that their protuberances 6 pass through the openings 19 of the first diptych panel 49 and of the second diptych panel 50.

The complementary diptych part 48 is folded back on the main diptych part 47 around the fold line forming the sides 58, 69, 66, 77, 62 and 73.

The third diptych panel 52 is attached, here by bonding, to the first diptych panel 49. Because of this, the blister plate 3 is sandwiched between the first and third diptych panels 49 and 52. The first diptych flap 15 is formed.

The same goes for the blister plate 4 which is sandwiched between the second and fourth diptych panels 50 and 53. The second diptych flap 16 is formed.

The second intermediate panel 54 is attached, here by bonding, to the first intermediate panel 51. The assembly of the first and second intermediate diptych panels 51 and 54 forms the diptych back 17.

The diptych part 27 is then folded back on the cover part 26 around the bridge 18, here around the fold line provided at the center of the bridge 18.

The diptych back 17 is attached, here by bonding, to the intermediate cover panel 30 forming the cover back 14.

The packaging 1 is then in the open configuration.

To place the packaging 1 in the closed configuration, the first diptych flap 15 and the second diptych flap 16 are folded relative to the diptych back 17, and the first cover flap 12 and the second cover flap 13 are folded relative to the cover back 14.

It will be observed that, in the blank 25, the cover part 26 and the diptych part 27 are not separate components; and that, on the contrary, these parts are joined by the bridge 18 to be one and the same blank 25.

Thus, apart from the blister plate 3 and the blister plate 4, just one component (the blank 25) is sufficient to obtain the packaging 1.

It will also be observed that there is no relative positioning required between the cover part 26 and the diptych part 27, since the bridge 18 which links them maintains their relative positioning.

It will finally be observed that, by virtue of the two grooves 8, the bridge 18 links only the intermediate panel 30 of the cover part 26 and the intermediate panel 51 of the diptych part 27 (and therefore, in the packaging 1, only a small side of the back 14 of the cover 10 to a small side of the back 17 of the diptych 11). Consequently, the blank 25 offers both a link between the cover part 26 and the diptych part 27 and the necessary independence between the panels used to form the flaps of the cover 10 and the panels used to form the flaps of the diptych 11.

There now follows a description, by reference to FIG. 4, of a variant of the blank 25 similar to the blank 25 illustrated in FIG. 3 apart from the fact that the third diptych panel 52 and the fourth diptych panel 53 are attached laterally respectively to the first diptych panel 49 and to the second diptych panel 50 rather than belonging to a complementary diptych part 48 similar to a main diptych part 47.

In the diptych part 27 of the blank 25 illustrated in FIG. 4, the second side 56 of the first diptych panel 49 and the second side 68 of the third diptych panel 52 are adjacent and formed by a fold line. The first side 67, the third side 69 and the fourth side 70 of the third diptych panel 52 are free.

Similarly, the second side 60 of the second diptych panel 50 and the second side 72 of the fourth diptych panel 53 are adjacent and formed by a fold line. The first side 71, the third side 73 and the fourth side 74 of the fourth diptych panel 53 are free.

The obtaining of the package 1 from the blank 25 illustrated in FIG. 4 and the blister plates 3 and 4 is similar to the obtaining of the package 1 from the blank 25 illustrated in FIG. 3, apart from the fact that the third diptych panel 52 and the fourth diptych panel 53 are folded back individually respectively over the first diptych panel 49 and over the second diptych panel 50; and apart from the fact that no action needs to be performed on the intermediate panel 54, which is absent.

Thus, in the packaging 1 obtained, the back 17 of the diptych 11 is formed only by the first intermediate diptych panel 51.

In the variant of the blank 25 illustrated in FIG. 5, the diptych part 27 comprises only the first diptych panel 49, the second diptych panel 50 and the first intermediate diptych panel 51.

To obtain the packaging 1, the blister plate 3 is bonded to the first diptych panel 49 and the blister plate 4 is bonded to the second diptych panel 5, the diptych part 27 is folded back over the cover part 26 and the first intermediate diptych panel 51 is attached to the intermediate cover panel 30, here also by bonding.

In variants not illustrated, the blank 25 used to form the case 2 is organized differently, with, for example, the same conformation as in FIG. 3 but without the second intermediate diptych panel 54; with the openings 19 of the first diptych panel 49 and of the second diptych panel 50 which are offset (and similarly, if necessary, for the openings 80 of the third diptych panel 52 and of the fourth diptych panel 53) so that the protuberances 6 of the blister plate 3 and the protuberances 6 of the blister plate 4 are offset; and/or with the closure device 21 which is formed differently, for example with two tongues such as 24 and two flaps such as 22.

As a variant, the unitary pharmaceutical products 7 are replaced by other lozenge products, for example food supplement tablets, pieces of chewing gum or effervescent bleach pellets.

Numerous other variants are possible according to the circumstances, and it will be recalled in this respect that the invention is not limited to the examples described and represented.

1. Packaging enclosing lozenge products (7), comprising a cover (10) and a diptych (11) arranged in said cover (10), said diptych (11) comprising a first flap (15) comprising a first blister plate (3), a second flap (16) comprising a second blister plate (4) and a back (17) arranged between said first flap (15) and said second flap (16); each said first blister plate (3) and second blister plate (4) comprising a film (9) and a base (5) having protuberances (6), each said lozenge product (7) being arranged in a cavity of one said protuberance (6) closed by said film (9); said cover (10) comprising a first flap (12), a second flap (13) and a back (14) arranged between said first flap (12) and said second flap (13); said back (17) of said diptych (11) being fixed to said back (14) of said cover (10), by virtue of which said packaging is organized in the manner of a book;
said packaging being characterized in that it comprises a case (2) comprising a cover part (26) and a diptych part (27), said cover part (26) forming said cover, said first blister plate (3) and second blister plate (4) and the diptych part (27) forming said diptych (11); an intermediate panel (30) of said cover part (26) forming said back (14) of said cover (10) and an intermediate panel (51) of said diptych part (27) forming said back (17) of said diptych (11), with a side (43) of said intermediate panel (30) of said cover part (26) which is linked by a bridge (18) to a side (65) of said intermediate panel (51) of said diptych part (27).

2. The packaging as claimed in claim 1, characterized in that said diptych part (27) comprises two panels (49, 52) sandwiching said first blister plate (3) and two panels (50, 53) sandwiching said second blister plate (4).

3. The packaging as claimed in claim 1, characterized in that said diptych part (27) comprises a single panel (49) to which said first blister plate (3) is fixed and a single panel (50) to which said second blister plate (3) is fixed.

4. The packaging as claimed in claim 1, characterized in that it comprises a closure device (21) for keeping said packaging in a closed configuration.

5. The packaging as claimed in claim 1, characterized in that said lozenge products are unitary pharmaceutical products (7).

6. A blank for obtaining a packaging as claimed in claim 1, characterized in that it comprises, to form a case (2) for said packaging (1):
a cover part (26) to form a cover (10) of said packaging (1), said cover part (26) comprising a first panel (28) to form a first flap (12) of said cover (10), a second panel (29) to form a second flap (13) of said cover (10), and an intermediate panel (30) arranged between said first panel (28) and said second panel (29) to form a back (14) of said cover (10);
a diptych part (27) to form a diptych (11) of said packaging (1), said diptych part (27) comprising a first panel (49) to receive a first blister plate (3) and to form with said first blister plate (3) a first flap (15) of said diptych (11), a second panel to receive a second blister plate (4) and to form with said second blister plate (4) a second flap (16) of said diptych (11), and an intermediate panel (51) arranged between said first panel (49) and said second panel (50) of said diptych part (27) to form a back (17) of said diptych (11); and
a bridge (18) linking a side (43) of said intermediate panel (30) of said cover part (26) to a side (65) of said intermediate panel (51) of said diptych part (27); a first groove (8) and a second groove (8) being arranged on either side of said bridge (18) and formed respectively between said first panel (28) of said cover part (26) and said first panel (49) of said diptych part (27), and between said second panel (29) of said cover part (26) and said second panel (50) of said diptych part (27).

7. The blank as claimed in claim 6, characterized in that each said groove (8) has a same width as said bridge (18).

8. The blank as claimed in claim 6, characterized in that said diptych part (27) further comprises a third panel (52) and a fourth panel (53), said diptych part (27) being configured to sandwich said first blister plate (3) between said first panel (49) and said third panel (52), and to sandwich said second blister plate (4) between said second panel (50) and said fourth panel (53).

9. The blank as claimed in claim 8, characterized in that said diptych part (27) comprises a main part (47) and a complementary part (48) organized in a manner similar to the main part (47), with said first panel (49) and said second panel (50) belonging to said main part (47), and with said third panel (52) and said fourth panel (54) belonging to said complementary part (48).

10. The blank as claimed in claim 8, characterized in that said third panel (52) has a side (68) adjacent to a side (56) of said first panel (49) whereas its other sides (67, 69, 70) are free; and said fourth panel (53) has a side (72) adjacent to a side (60) of said second panel (50) whereas its other sides (71, 73, 74) are free.

11. The blank as claimed in claim 6, characterized in that said diptych part (27) comprises no panel other than said first panel (49), said second panel (50) and said intermediate panel (51).
